(19) United States
(12) Patent Application Publication
(10) Pub. No.: US 2022/0204027 A1
(43) Pub. Date: Jun. 30, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Sho Hitakatsu, Wako-shi (JP); Toshikazu Suwa, Tokyo (JP); Masaki Nakajima, Yokohama-shi (JP)

(21) Appl. No.: 17/552,371

(22) Filed: Dec. 16, 2021

(30) Foreign Application Priority Data
Dec. 28, 2020 (JP) 2020-218190

(51) Int. Cl. B60W 60/00

(52) U.S. Cl. CPC B60W 60/005; B60W 60/001; B60W 2552/50; B60W 2552/05; B60W 2552/53

(57) ABSTRACT

A vehicle control device according to an embodiment controls automated driving of a vehicle. The vehicle control device includes a processor configured to execute a program to perform acquiring map information in which a recommended lane on a route to a destination of the vehicle is identified, and controlling a control level of the automated driving on the basis of the acquired map information. The processor is further configured to lower the control level of the automated driving when a boundary line of the recommended lane is not recognizable within a predetermined distance in a travel direction of the vehicle.

### CROSS-REFERENCE TO RELATED APPLICATION

Priority is claimed on Japanese Patent Application No. 2020-218190, filed Dec. 28, 2020, the content of which is incorporated herein by reference.

### BACKGROUND

### Field of the Invention

The present invention relates to a vehicle control device, a vehicle control method, and a storage medium.

### Description of Related Art

In the related art, an automated driving notification system that notifies whether automated driving is possible by repeatedly determining whether there is map information with high precision which is required for performing automated driving for a road on which a host vehicle passes is known (for example, Japanese Unexamined Patent Application, First Publication No. 2018-189594).

### SUMMARY

In the related art, whether automated driving is possible is determined based on whether there is high-precision map information, but even if there is high-precision map information, automated driving cannot be accurately controlled when the map data is damaged or when erroneous map data is stored.

The present invention was made in consideration of the aforementioned circumstances and an objective thereof is to provide a vehicle control device, a vehicle control method, and a storage medium that can change a control level of automated driving according to appropriate conditions.

A vehicle control device, a vehicle control method, and a storage medium according to the present invention employ the following configurations.

(1) A vehicle control device according to one aspect of the present invention controls automated driving of a vehicle. The vehicle control device includes a processor configured to execute a program to perform acquiring map information in which a recommended lane on a route to a destination of the vehicle is identified, and controlling a control level of the automated driving on the basis of the acquired map information. The processor is further configured to lower the control level of the automated driving when a boundary line of the recommended lane is not recognizable within a predetermined distance in a travel direction of the vehicle.

(2) In the vehicle control device according to the aspect of (1), the processor is further configured to lower the control level of the automated driving when a block obtained by dividing the route by every predetermined distance in the map information is not recognizable.

(3) In the vehicle control device according to the aspect of (1) or (2), the processor is further configured to lower the control level of the automated driving when a center line of the recommended lane in the map information is not recognizable.

(4) In the vehicle control device according to any aspect of (1) to (3), the processor is further configured to lower the control level of the automated driving when a branching lane is present in the map information and a main lane associated with the branching lane is not recognizable.

(5) In the vehicle control device according to any aspect of (1) to (4), the processor is further configured to lower the control level of the automated driving when information indicating presence of an exit lane as a connection destination of a certain lane is included in the map information and the exit lane is not recognizable.

(6) In the vehicle control device according to any aspect of (1) to (5), the processor is further configured to lower the control level of the automated driving when information of a median strip in the map information departs from a prescribed value.

(7) In the vehicle control device according to any aspect of (1) to (6), the processor is further configured to lower the control level of the automated driving when a merging lane is present in the map information and a neighboring lane associated with the merging lane is not recognizable.

(8) In the vehicle control device according to any aspect of (1) to (7), the processor is further configured to lower the control level of the automated driving when at least a part of the recommended lane in the map information is not recognizable.

(9) In the vehicle control device according to any aspect of (1) to (8), the processor is further configured to lower the control level of the automated driving when the map information is invalid.

(10) In the vehicle control device according to any aspect of (1) to (9), the processor is further configured to lower the control level of the automated driving when a lane in the map information is not recognizable.

(11) A vehicle control method according to another aspect of the present invention is performed by a computer mounted in a vehicle. The control method includes acquiring map information in which a recommended lane on a route to a destination of the vehicle is identified, and controlling a control level of automated driving of the vehicle on the basis of the acquired map information. The controlling of the control level includes lowering the control level of the automated driving when a boundary line of the recommended lane is not recognizable within a predetermined distance in a travel direction of the vehicle.

(12) A non-transitory computer-readable storage medium according to still another aspect of the present invention stores a program. The program causes a computer mounted in a vehicle to perform acquiring map information in which a recommended lane on a route to a destination of the vehicle is identified, and controlling a control level of automated driving of the vehicle on the basis of the acquired map information. The controlling of the control level includes lowering the control level of the automated driving when a boundary line of the recommended lane is not recognizable within a predetermined distance in a travel direction of the vehicle.

According to the aspect, it is possible to change a control level of automated driving according to appropriate conditions.

### BRIEF DESCRIPTION OF THE DRAWINGS

FIG. 1 is a diagram showing a configuration of a vehicle system employing a vehicle control device according to an embodiment;

FIG. 2 is a diagram showing functional configurations of a first controller and a second controller according to the embodiment.

FIG. 3 is a diagram showing an example of correspondence between driving modes and control states of a host vehicle and tasks according to the embodiment.

FIG. 4 is a flowchart showing an example of a lane determining process which is performed by an automated driving control device 100 according to the embodiment.

FIG. 5 is a diagram showing an example of a situation in which a lane boundary line of a recommended lane in recommended lane map information is not recognizable.

FIG. 6 is a diagram showing an example of a situation in which a block of a recommended lane in the recommended lane map information is not recognizable.

FIG. 7 is a diagram showing an example of a situation in which a lane center line of a recommended lane in the recommended lane map information is not recognizable.

FIG. 8 is a diagram showing an example of a situation in which a main lane associated with a branching lane in the recommended lane map information is not recognizable.

FIG. 9 is a diagram showing an example of a situation in which an exit lane in the recommended lane map information is not recognizable.

FIG. 10 is a diagram showing an example of a situation in which a neighboring lane associated with a merging lane in the recommended lane map information is not recognizable.

### DESCRIPTION OF EMBODIMENTS

Hereinafter, a vehicle control device, a vehicle control method, and a storage medium according to an embodiment of the present invention will be described with reference to the accompanying drawings.

[Overall Configuration]

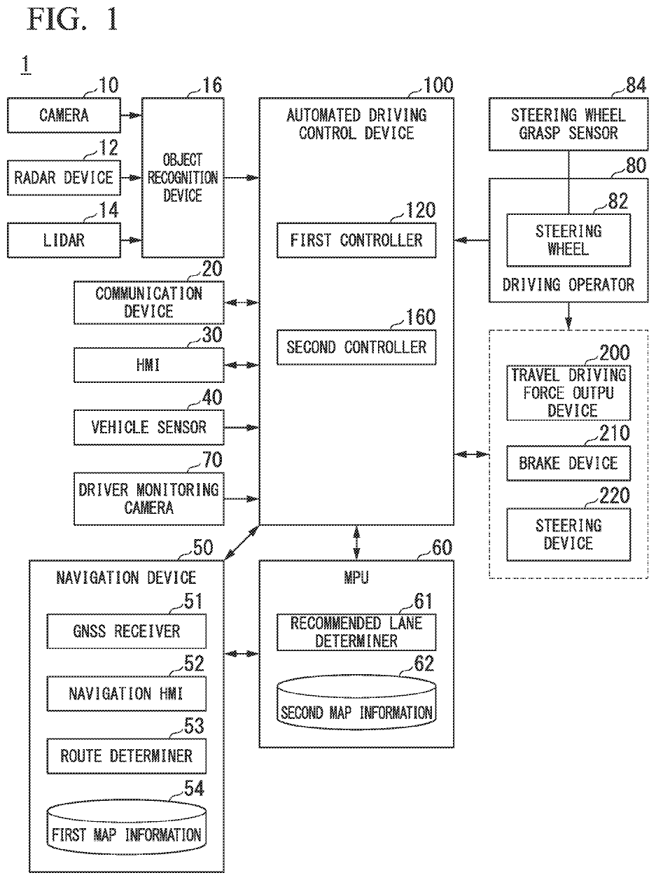

FIG. 1 is a diagram showing a configuration of a vehicle system 1 using a vehicle control device according to an embodiment. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. The electric motor operates using electric power generated by a power generator connected to the internal combustion engine or electric power discharged from a secondary battery or a fuel battery.

The vehicle system 1 includes, for example, a camera 10, a radar device 12, a Light Detection and Ranging (LIDAR) 14, an object recognition device 16, a communication device 20, a human-machine interface (HMI) 30, a vehicle sensor 40, a navigation device 50, a map positioning unit (MPU) 60, a driver monitoring camera 70, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration shown in FIG. 1 is only an example and a part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle in which the vehicle system 1 is mounted (hereinafter, referred to as a host vehicle M). For example, when the front view of the host vehicle M is imaged, the camera 10 is attached to an upper part of a front windshield, a rear surface of a rearview mirror, or the like. The camera 10 images the surroundings of the host vehicle M, for example, periodically and repeatedly. The camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR 14 radiates light (or electromagnetic waves of wavelengths close to light) to the surroundings of the host vehicle M and measures scattered light. The LIDAR 14 detects a distance to an object on the basis of a time from radiation of light to reception of light. The radiated light is, for example, a pulse-like laser beam. The LIDAR 14 is attached to an arbitrary position on the host vehicle M.

The object recognition device 16 performs a sensor fusion process on results of detection from some or all of the camera 10, the radar device 12, and the LIDAR 14 and recognizes the position, the type, the speed, and the like of an object. The object recognition device 16 outputs the result of recognition to the automated driving control device 100. The object recognition device 16 may output the results of detection from the camera 10, the radar device 12, and the LIDAR 14 to the automated driving control device 100 without any change. The object recognition device 16 may be omitted from the vehicle system 1.

The communication device 20 communicates with other vehicles near the host vehicle M, for example, using a cellular network, a Wi-Fi network, Bluetooth (registered trademark), or dedicated short range communication (DSRC) or communicates with various server devices via a radio base station.

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects the acceleration, and a direction sensor that detects the direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory.

The GNSS receiver 51 identifies a position of the host vehicle M on the basis of signals received from GNSS satellites (radio waves received from satellites). The position of the host vehicle M may be identified or complemented by an inertial navigation system (INS) using the output of the vehicle sensor 40. The navigation HMI 52 includes a display device, a speaker, a touch panel, keys, and the like. A whole or a part of the navigation HMI 52 may be shared by the HMI 30. For example, the route determiner 53 determines a route (hereinafter, referred to as a route on a map) from the position of the host vehicle M identified by the GNSS receiver 51 (or an input arbitrary position) to a destination input by an occupant using the navigation HMI 52 with reference to the first map information 54.

The first map information 54 is, for example, information in which a road shape is expressed by links indicating a road and nodes connected by the links. The first map information 54 may include a curvature of a road or point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 is realized by causing a hardware processor (a computer) such as a central processing unit (CPU) to execute a program (software). The recommended lane determiner 61 may be realized by hardware (which includes circuitry) such as a large scale integration (LSI), an application specific integrated circuit (ASIC), a field-programmable gate array (FPGA), or a graphics processing unit (GPU) or may be realized by cooperation of software and hardware. The program may be stored in a storage device (a storage device including a non-transitory storage medium) of the MPU 60 in advance, or may be stored in in a removable storage medium such as a DVD or a CD-ROM and installed in the storage device of the MPU 60 by attaching the removable storage medium (non-transitory storage medium) to a drive device.

The recommended lane determiner 61 divides a route on a map supplied from the navigation device 50 into a plurality of blocks (for example, every 100 [m] in a vehicle travel direction) and determines a recommended lane for each block with reference to the second map information 62. The recommended lane determiner 61 determines in which lane from the leftmost the host vehicle is to travel. When there is a branching point in the route on a map, the recommended lane determiner 61 determines a recommended lane such that the host vehicle M travels along a rational route for traveling to a branching destination.

The second map information 62 is map information with higher precision than the first map information 54. The second map information 62 includes, for example, information on the centers of lanes (lane center lines, center lines) or information on boundaries of lanes (lane boundary lines, boundary lines). The second map information 62 may include road information, traffic regulation information, address information (addresses and postal codes), facility information, phone number information, information on a prohibited section in which mode A or mode B which will be described later is prohibited. The second map information 62 may be updated from time to time by causing the communication device 20 to communicate with another device.

The driver monitoring camera 70 is, for example, a digital camera using a solid-state imaging device such as a CCD or a CMOS. The driver monitoring camera 70 is attached to an arbitrary position on the host vehicle M in a place and direction in which the head of an occupant (hereinafter referred to as a driver) sitting on a driver's seat of the host vehicle M can be imaged from the front (such that the face of the driver is imaged). For example, the driver monitoring camera 70 is attached to an upper part of a display device which is provided at the central part of an instrument panel of the host vehicle M.

The driving operator 80 includes, for example, an accelerator pedal, a brake pedal, a shift lever, and other operators in addition to a steering wheel 82. A sensor that detects an amount of operation or performing of an operation is attached to the driving operator 80. Results of detection of the sensor are output to the automated driving control device 100 or output to some or all of the travel driving force output device 200, the brake device 210, and the steering device 220. The steering wheel 82 is an example of an “operator that receives a driver's steering operation.” The steering wheel 82 does not have to a ring shape and may have a shape such as a deformed steering wheel, a joystick, or a button. A steering wheel grasp sensor 84 is attached to the steering wheel 82. The steering wheel grasp sensor 84 is realized by a capacitance sensor or the like and outputs a signal indicating whether a driver grasps the steering wheel 82 (which means contacting the steering wheel with a force applied thereto) to the automated driving control device 100.

The automated driving control device 100 includes, for example, a first controller 120 and a second controller 160. The first controller 120 and the second controller 160 are realized, for example, by causing a hardware processor (a computer) such as a CPU to execute a program (software). Some or all of such elements may be realized by hardware (which includes circuitry) such as an LSI, an ASIC, or an FPGA, or a GPU or may be realized in cooperation of software and hardware. The program may be stored in a storage device (a storage device including a non-transitory storage medium) such as an HDD or a flash memory of the automated driving control device 100 in advance, or may be stored in a removable storage medium such as a DVD or a CD-ROM and installed in the HDD or the flash memory of the automated driving control device 100 by attaching the removable storage medium (non-transitory storage medium) to a drive device.

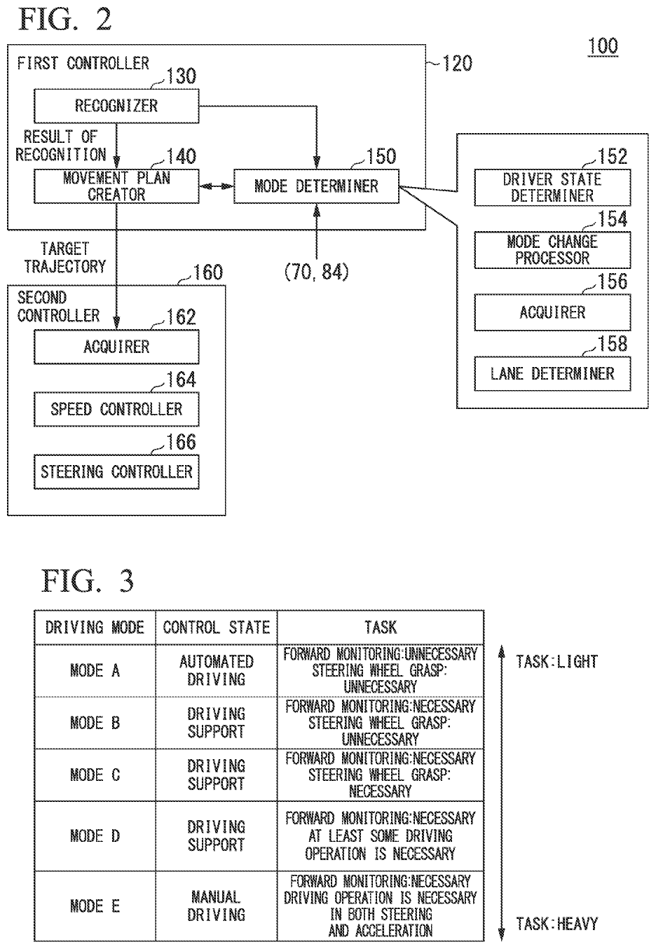

FIG. 2 is a diagram showing functional configurations of the first controller 120 and the second controller 160. The first controller 120 includes, for example, a recognizer 130, a movement plan creator 140, and a mode determiner 150. The automated driving control device 100 is an example of a “vehicle control device.”

For example, the first controller 120 realizes a function based on artificial intelligence (AI) and a function based on a predetermined model together. For example, a function of “recognizing a crossing” may be realized by performing recognition of a crossing based on deep learning or the like and recognition based on predetermined conditions (such as signals and road signs which can be pattern-matched) together, scoring both recognitions, and comprehensively evaluating the recognitions. Accordingly, reliability of automated driving is secured.

The recognizer 130 recognizes states such as the position, the speed, and the acceleration of an object near the host vehicle M on the basis of information input from the camera 10, the radar device 12, and the LIDAR 14 via the object recognition device 16. For example, the position of an object is recognized as the position in an absolute coordinate system with an origin set to a representative point of the host vehicle M (such as the center of gravity or the center of a drive shaft) and is used for control. The position of an object may be expressed as a representative point such as the center of gravity or a corner of the object or may be expressed as an area. The “state” of an object may include an acceleration or a jerk of the object or a “moving state” (for example, whether a lane change is being performed or whether a lane change is going to be performed) thereof.

The recognizer 130 determines, for example, a lane (a travel lane) in which the host vehicle M is traveling. For example, the recognizer 130 recognizes the travel lane by comparing a pattern of lane boundary lines near the host vehicle M which are recognized from an image captured by the camera 10 with a pattern of lane boundary lines (for example, arrangement of a solid line and a dotted line) which are acquired from the second map information 62. The recognizer 130 may recognize the travel lane by recognizing, not limited to the lane boundary lines, travel road boundaries (road boundaries) including lane boundary lines, edges of roadsides, curbstones, median strips, and guard rails. In this recognition, the position of the host vehicle M acquired from the navigation device 50 and the result of processing from the INS may be considered. The recognizer 130 recognizes a stop line, an obstacle, a red signal, a toll gate, or other road events.

The recognizer 130 recognizes a position or a direction of the host vehicle M with respect to a travel lane at the time of recognition of the travel lane. The recognizer 130 may recognize, for example, a separation of a reference point of the host vehicle M from the lane center and an angle of the travel direction of the host vehicle M with respect to a line formed by connecting the lane centers in the travel direction of the host vehicle M as the position and the direction of the host vehicle M relative to the travel lane. Instead, the recognizer 130 may recognize the position of a reference point of the host vehicle M relative to one side line of the travel lane (a lane boundary line or a road boundary) or the like as the position of the host vehicle M relative to the travel lane.

The movement plan creator 140 creates a target trajectory in which the host vehicle M will travel autonomously (without requiring a driver's operation) in the future such that the host vehicle M can travel in a recommended lane determined by the recommended lane determiner 61 in principle and cope with surrounding circumstances of the host vehicle M. A target trajectory includes, for example, a speed element. For example, a target trajectory is expressed by sequentially arranging points (trajectory points) at which the host vehicle M is to arrive. Trajectory points are points at which the host vehicle M is to arrive at intervals of a predetermined traveling distance (for example, about several [m]) along a road, and a target speed and a target acceleration at intervals of a predetermined sampling time (for example, approximately below the decimal point [sec]) are created as a part of the target trajectory in addition. Trajectory points may be positions at which the host vehicle M is to arrive at sampling times every predetermined sampling time. In this case, information of a target speed or a target acceleration is expressed by intervals between the trajectory points.

The movement plan creator 140 may set events of automated driving in creating a target trajectory. The events of automated driving include a constant-speed travel event, a low-speed following travel event, a lane change event, a branching event, a merging event, and an overtaking event. The movement plan creator 140 creates a target trajectory based on events which are started.

The mode determiner 150 determines one of a plurality of driving modes with different tasks to be imposed on a driver as a driving mode of the host vehicle M. The mode determiner 150 includes, for example, a driver state determiner 152, a mode change processor 154, an acquirer 156, and a lane determiner 158. These individual functions will be described later. The acquirer 156 is an example of an “acquirer.” A combination of the mode change processor 154 and the lane determiner 158 is an example of a “controller.”

FIG. 3 is a diagram showing an example of correspondence between driving modes and control states of the host vehicle M and tasks. The driving mode of the host vehicle M includes, for example, five modes including mode A to mode E. A control state, that is, an automation level (a control level) of driving control of the host vehicle M, is the highest in mode A, decreases in the order of mode B, mode C, and mode D, and is the lowest in mode E. On the other hand, a task to be imposed on a driver is the lightest in mode A, becomes heavier in the order of mode B, mode C, and mode D, and is the heaviest in mode E. In mode D and mode E, since the control state is not automated driving, the automated driving control device 100 has to end control associated with automated driving and take charge of transitioning to driving support or manual driving. Details of the driving modes will be exemplified below.

In mode A, the control state is an automated driving state and none of forward monitoring and grasping of the steering wheel 82 (steering wheel grasp in the drawing) is imposed on a driver. Even in mode A, the driver is requested to take a posture that can rapidly transition to manual driving in response to a request from a system centered on the automated driving control device 100. Automated driving mentioned herein means that both steering and acceleration/deceleration are controlled without requiring a driver's operation. Forward means a space in the travel direction of the host vehicle M which is seen via a front windshield. For example, mode A is a driving mode which is executable when conditions in which the host vehicle M is traveling at a predetermined speed (for example, about 50 [km/h]) or lower on a motorway such as a highway and a preceding vehicle to be followed is present are satisfied and is also referred to as traffic jam pilot (TJP). When the conditions are not satisfied, the mode determiner 150 changes the driving mode of the host vehicle M to mode B.

In mode B, the control state is a driving support state, a task for monitoring a space in front of the host vehicle M (hereinafter referred to as forward monitoring) is imposed on a driver, and a task for grasping the steering wheel 82 is not imposed on the driver. In mode C, the control state is a driving support state, and the task for forward monitoring and the task for grasping the steering wheel 82 are imposed on a driver. Mode D is a driving mode in which a driver's driving operation to a certain extent is required for at least one of steering and acceleration/deceleration of the host vehicle M. For example, in mode D, driving support such as adaptive cruise control (ACC) or a lane keeping assist system (LKAS) is performed. In mode E, the control state is a manual driving state in which a driver's driving operation is required for both steering and acceleration/deceleration. In both mode D and mode E, the task for monitoring the space in front of the host vehicle M is imposed on a driver.

The automated driving control device 100 (and a driving support device (not shown)) performs an automatic lane change corresponding to a driving mode. The automatic lane change includes an automatic lane change (1) based on a system request and an automatic lane change (2) based on a driver request. The automatic lane change (1) includes an automatic lane change for overtaking which is performed when a speed of a preceding vehicle is lower by a reference value or more than the speed of the host vehicle and an automatic lane change for traveling to a destination (automatic lane change due to change of a recommended lane). The automatic lane change (2) is an automatic lane change for changing the travel lane of the host vehicle M in an indicated direction when conditions associated with a speed or a positional relationship with nearby vehicles, or the like are satisfied and a direction indicator is operated by a driver.

The automated driving control device 100 does not perform any of the automatic lane change (1) and the automatic lane change (2) in mode A. The automated driving control device 100 performs both the automatic lane change (1) and the automatic lane change (2) in mode B and mode C. The driving support device (not shown) does not perform the automatic lane change (1) but performs the automatic lane change (2) in mode D. In mode E, none of the automatic lane change (1) and the automatic lane change (2) is performed.

The mode determiner 150 changes the driving mode of the host vehicle M to a driving mode with a heavier task when a task associated with the determined driving mode (hereinafter referred to as a current driving mode) is not performed by a driver.

For example, in mode A, when a driver takes a posture with which the driver cannot transition to manual driving in response to a request from a system (for example, when the driver is looking off a permitted area or when a sign for making driving difficult is detected), the mode determiner 150 performs control such that the driver is urged to transition to manual driving using the HMI 30, and the host vehicle M is put on a road edge and slowly stopped and automated driving is stopped when the driver does not respond. After automated driving has been stopped, the host vehicle is in mode D or E and the host vehicle M can be started by the driver's manual operation. This is the same for “stopping of automated driving.” When a driver does not monitor the space in front of the host vehicle in mode B, the mode determiner 150 performs control such that the driver is urged to perform forward monitoring using the HMI 30, and the host vehicle M is put on a road edge and slowly stopped and automated driving is stopped when the driver does not respond. In mode C, when a driver does not perform forward monitoring or when a driver does not grasp the steering wheel 82, the mode determiner 150 performs control such that the driver is urged to perform forward monitoring or grasping of the steering wheel 82 using the HMI 30, and the host vehicle M is put on a road edge and slowly stopped and automated driving is stopped when the driver does not respond.

The driver state determiner 152 monitors a driver's state for the mode change and determines whether the driver's state is a state corresponding to a task. For example, the driver state determiner 152 performs a posture estimating process by analyzing an image captured by the driver monitoring camera 70 and determines whether the driver takes a posture with which the driver cannot transition to manual driving in response to a request from the system. The driver state determiner 152 performs a sightline estimating process by analyzing an image captured by the driver monitoring camera 70 and determines whether the driver is monitoring a space in front.

The mode change processor 154 performs various processes for mode change. For example, the mode change processor 154 instructs the movement plan creator 140 to create a target trajectory for stopping on a road edge, instructs a driving support device (not shown) to operate, or performs the HMI 30 such that the driver is urged to perform behavior. The mode change processor 154 lowers a control level when the lane determiner 158 which will be described later determines that a lane boundary line of a recommended lane is not recognizable.

The acquirer 156 acquires map information in which a recommended lane on a route to a destination of the host vehicle M is identified and which is output from the MPU 60 (hereinafter referred to as “recommended lane map information”). The recommended lane map information is high-precision map information in which a recommended lane is identified on the second map information 62.

The lane determiner 158 determines whether a lane boundary line of a recommended lane is recognizable within a predetermined distance in the travel direction of the host vehicle M with reference to the recommended lane map information acquired by the acquirer 156. When the recommended lane map information does not include information of lane boundary lines, when at least a part of the information of lane boundary lines is damaged, when the information of lane boundary lines departs from a prescribed value, or the like, the lane determiner 158 determines that a lane boundary line of the recommended lane is not recognizable.

Such an abnormality of the recommended lane map information may occur, for example, when a hardware failure (such as a failure of a storage device) or a software failure occurs in the MPU 60, when a failure (a loss of data due to a communication failure) occurs at the time of updating map data, when erroneous map data is stored, when information of a newly open road is not reflected in map data, or the like. Details of the process which is performed by the lane determiner 158 will be described later.

Referring back to FIG. 2, the second controller 160 controls the travel driving force output device 200, the brake device 210, and the steering device 220 such that the host vehicle M travels along a target trajectory created by the movement plan creator 140 as scheduled.

The second controller 160 includes, for example, an acquirer 162, a speed controller 164, and a steering controller 166. The acquirer 162 acquires information of a target trajectory (trajectory points) created by the movement plan creator 140 and stores the acquired information in a memory (not shown). The speed controller 164 controls the travel driving force output device 200 or the brake device 210 on the basis of a speed element accessory to the target trajectory stored in the memory. The steering controller 166 controls the steering device 220 on the basis of a curve state of the target trajectory stored in the memory. The processes of the speed controller 164 and the steering controller 166 are realized, for example, in combination of feed-forward control and feedback control. For example, the steering controller 166 performs control in combination of feed-forward control based on the curvature of a road in front of the host vehicle M and feedback control based on a separation from the target trajectory.

The travel driving force output device 200 outputs a travel driving force (a torque) for allowing the vehicle to travel to driving wheels. The travel driving force output device 200 includes, for example, a combination of an internal combustion engine, an electric motor, and a transmission and an electronic control unit (ECU) that controls them. The ECU controls the elements on the basis of information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the driving operator 80 such that a brake torque based on a braking operation is output to vehicle wheels. The brake device 210 may include a mechanism for transmitting a hydraulic pressure generated by an operation of a brake pedal included in the driving operator 80 to the cylinder via a master cylinder as a backup. The brake device 210 is not limited to the above-mentioned configuration, and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 80 to change the direction of the turning wheels.

[Lane Determining Process]

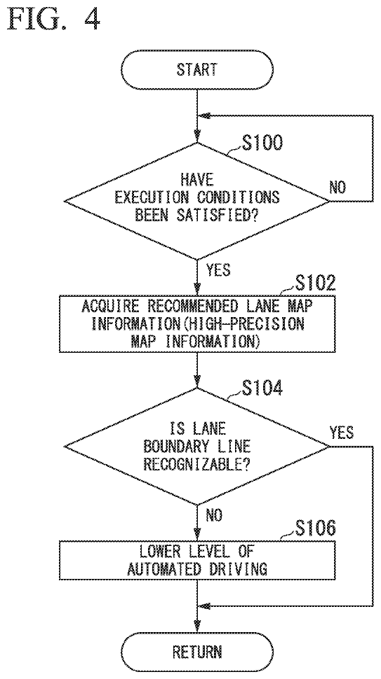

A lane determining process will be described below with reference to a flowchart. FIG. 4 is a flowchart showing an example of the lane determining process which is performed by the automated driving control device 100. In the following description, it is assumed that the host vehicle M is traveling in a driving mode determined by the mode determiner 150 (for example, mode A or mode B) along the target trajectory created by the movement plan creator 140 by automated driving control.

First, the mode determiner 150 waits until execution conditions are satisfied (Step S100). The execution conditions are conditions for performing the lane determining process in the flowchart and include the following several conditions.

Condition (i): The automated driving control device 100 acquires the second map information 62 from the MPU 60.

Condition (ii): The host vehicle M does not travel in a prohibited section in which mode A or mode B is prohibited.

Condition (iii): No abnormality has occurred in a process using the second map information 62 in the automated driving control device 100.

When the execution conditions are satisfied, the acquirer 156 of the mode determiner 150 acquires recommended lane map information (high-precision map information) output from the MPU 60 (Step S102).

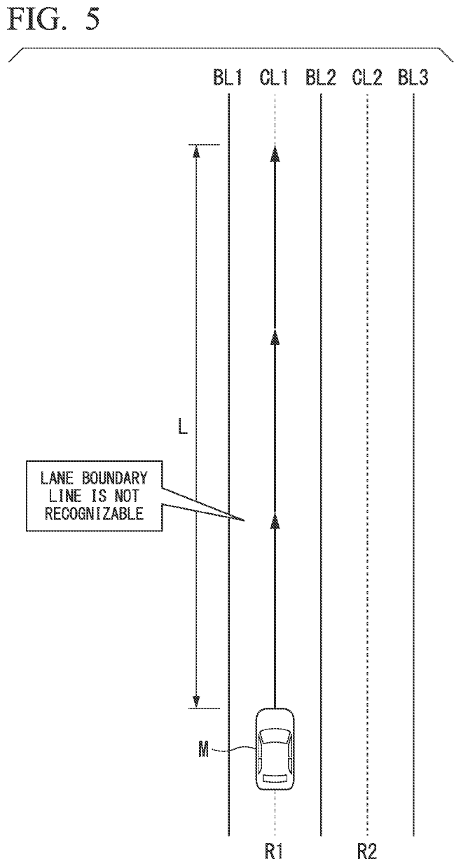

Then, the lane determiner 158 determines whether a lane boundary line of a recommended lane is recognizable within a predetermined distance in the travel direction of the host vehicle M with reference to the recommended lane map information acquired by the acquirer 156 (Step S104). FIG. 5 is a diagram showing an example of a situation in which a lane boundary line of a recommended lane in the recommended lane map information is not recognizable. FIG. 5 shows a two-lane road including a lane R1 (a recommended lane) in which the host vehicle M is traveling and a lane R2 which is an overtaking lane. The lane R2 may be an oncoming lane. In the recommended lane map information, the lane R1 is defined by a lane boundary line BL1 and a lane boundary line BL2, and a lane center line CL1 is set between the lane boundary line BL1 and the lane boundary line BL2. In the recommended lane map information, the lane R2 is defined by the lane boundary line BL2 and a lane boundary line BL3, and a lane center line CL2 is set between the lane boundary line BL2 and the lane boundary line BL3. The lane determiner 158 determines whether both the lane boundary lines BL1 and BL2 of the lane R1 which is a recommended lane are recognizable within a predetermined distance L in the travel direction of the host vehicle M. Alternatively, the lane determiner 158 may determine whether at least one of the lane boundary lines BL1 and BL2 of the lane R1 which is a recommended lane is recognizable within the predetermined distance L in the travel direction of the host vehicle M.

As shown in FIG. 5, the lane determiner 158 also determines that a lane boundary line is not recognizable when abnormal states (1) to (6) which will be described below have been ascertained as well as when a lane boundary line cannot be directly recognized.

(1) Unrecognizability of Block

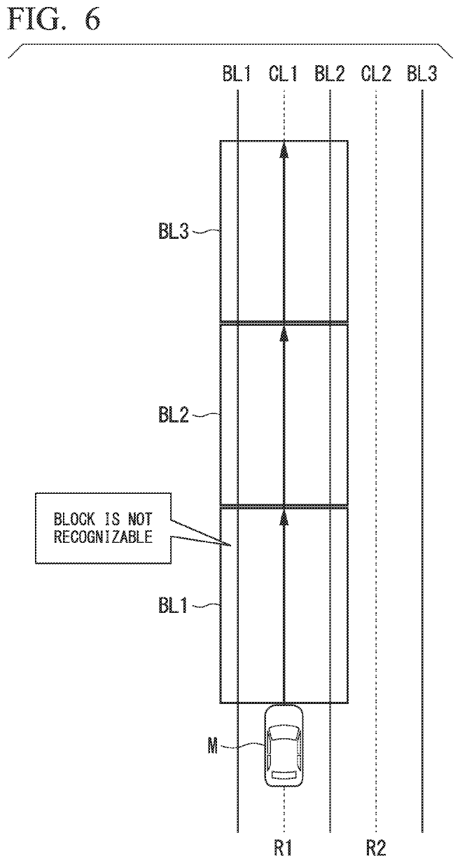

When blocks into which a route on a map is divided by a predetermined distance (for example, blocks divided every 100 [m] in the vehicle travel direction) are not recognizable in the recommended lane map information, the lane determiner 158 determines that a lane boundary line is not recognizable. FIG. 6 is a diagram showing an example of a situation in which a block of a recommended lane in the recommended lane map information is not recognizable. FIG. 6 shows three successive blocks BL1, BL2, and BL3 which are set in the travel direction of the host vehicle M. The lane determiner 158 determines that a lane boundary line is not recognizable when all or at least one of the blocks BL1, BL2, and BL3 is not recognizable.

(2) Unrecognizability of Lane Center Line

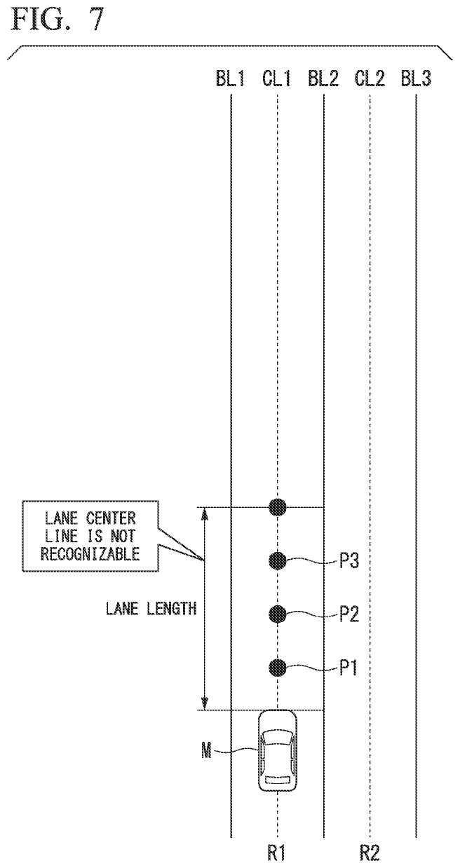

When a lane center line of a recommended lane is not recognizable in the recommended lane map information, the lane determiner 158 determines that a lane boundary line is not recognizable. FIG. 7 is a diagram showing an example of a situation in which a lane center line of a recommended lane in the recommended lane map information is not recognizable. As shown in FIG. 7, a lane center line in the recommended lane map information is expressed by coordinate points (P1, P2, and P3) with a predetermined interval. For example, when a lane length of the lane center line defined by the coordinate points (P1, P2, and P3) is 0 m is determined to be 0 m, the lane determiner 158 determines that a lane boundary line is not recognizable. Alternatively, when intervals between the coordinate points (P1, P2, and P3) are different or when continuity cannot be secured, the lane determiner 158 determines that a lane boundary line is not recognizable.

(3) Unrecognizability of Branching Lane

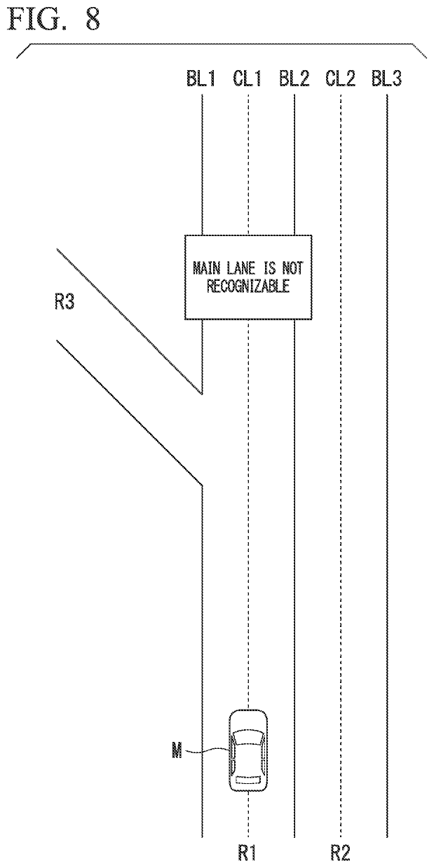

When a branching lane is present in the recommended lane map information and a main lane associated with the branching lane is not recognizable, the lane determiner 158 determines that a lane boundary line is not recognizable. FIG. 8 is a diagram showing an example of a situation in which a main lane associated with a branching lane in the recommended lane map information is not recognizable. In the example shown in FIG. 8, a branching lane R3 is present in the travel direction of the host vehicle M in the recommended lane map information. When the branching lane R3 is present in the recommended lane map information but a lane R1 which is a main lane which is to be present and which is associated with the branching lane R3 is not recognizable, the lane determiner 158 determines that a lane boundary line is not recognizable.

(4) Unrecognizability of Exit Lane

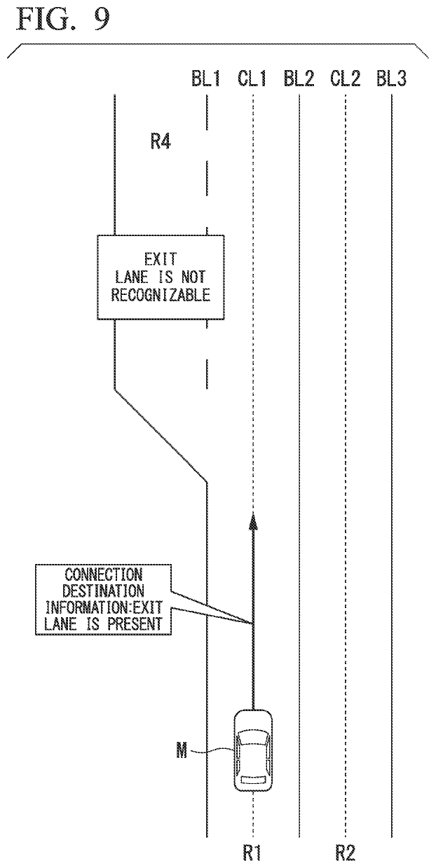

When information indicating presence of an exit lane which is a connection destination of a certain lane (a link indicating a road) is included in the recommended lane map information and the exit lane is not recognizable, the lane determiner 158 determines that a lane boundary line is not recognizable. FIG. 9 is a diagram showing an example of a situation in which an exit lane in the recommended lane map information is not recognizable. In the example shown in FIG. 9, presence of an exit lane R4 is included as information of a lane which is a connection destination of a certain lane in the travel direction of the host vehicle M in the recommended lane map information. When presence of the exit lane R4 as a connection destination of a certain lane is included in the recommended lane map information but the exit lane R4 is not recognizable, the lane determiner 158 determines that a lane boundary line is not recognizable.

(5) Unrecognizability of Neighboring Lane

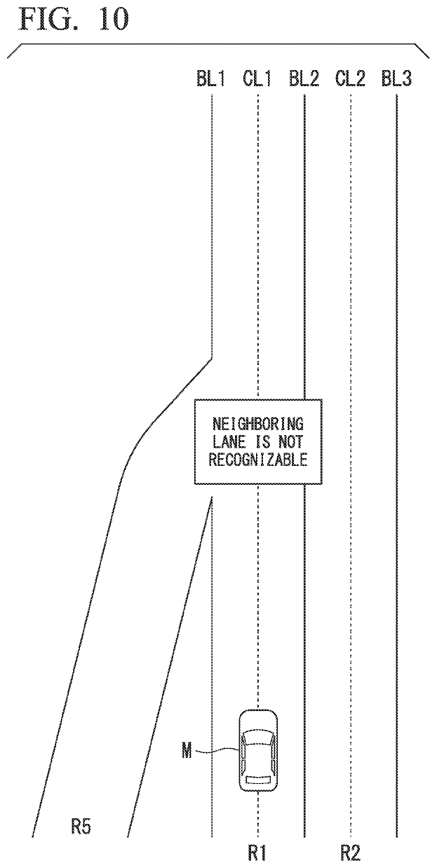

When a merging lane is present in the recommended lane map information and a neighboring lane associated with the merging lane is not recognizable, the lane determiner 158 determines that a lane boundary line is not recognizable. FIG. 10 is a diagram showing an example of a situation in which a neighboring lane associated with a merging lane in the recommended lane map information is not recognizable. In the example shown in FIG. 10, a merging lane R5 is present in the travel direction of the host vehicle M in the recommended lane map information. When the merging lane R5 is present in the recommended lane map information but a neighboring lane (lane R1) associated with the merging lane R5 is not recognizable, the lane determiner 158 determines that a lane boundary line is not recognizable.

(6) Other Unrecognizability

In addition, when information of a median strip in the recommended lane map information departs from a prescribed value, the lane determiner 158 determines that a lane boundary line is not recognizable. Examples of the case in which the information departs from the prescribed value include a case in which information of a median strip is damaged, a case in which information of a part is insufficient, and a case in which a distance from the lane center line is equal to or greater than or equal to or less than a prescribed value. When at least a part of the recommended lane in the recommended lane map information is not recognizable, the lane determiner 158 determines that a lane boundary line is not recognizable. When the recommended lane map information is invalid, the lane determiner 158 determines that a lane boundary line is not recognizable. When a lane in the recommended lane map information is not recognizable, the lane determiner 158 determines that a lane boundary line is not recognizable.

Referring back to FIG. 4, when the lane determiner 158 determines that a lane boundary line of a recommended lane is recognizable, the mode change processor 154 continues to control automated driving in a current driving mode without changing the driving mode for automated driving. On the other hand, when the lane determiner 158 determines that a lane boundary line of a recommended lane is not recognizable, the mode change processor 154 changes the driving mode to an automated driving mode of a lower control level (Step S106). For example, when the driving mode of the host vehicle M is mode A or mode B, the mode change processor 154 changes the driving mode to mode C, mode D, or mode E which is lower in control level than in mode B. In other words, when the driving mode of the host vehicle M is mode A or mode B, the mode change processor 154 changes the driving mode to mode C, mode D, or mode E which is heavier in task imposed to an occupant than in mode B.

As described above, mode A and mode B are modes in which grasping of the steering wheel 82 is not imposed as a task on an occupant. On the other hand, mode C, mode D, and mode E are modes in which grasping of the steering wheel 82 is imposed as a task on an occupant. Accordingly, when the lane determiner 158 determines that a lane boundary line of a recommended lane is not recognizable, the mode change processor 154 changes the driving mode of the host vehicle M to a mode in which grasping of the steering wheel 82 is imposed as a task on an occupant. Thereafter, the routine of the flowchart ends.

The vehicle control device according to the aforementioned embodiment includes the acquirer 156 (an acquirer) that acquires recommended lane map information (map information) in which a recommended lane on a route to a destination of the host vehicle M is identified and the lane determiner 158 and the mode change processor 154 (a controller) that control the control level of automated driving on the basis of the acquired map information. The controller can change the control level of automated driving according to appropriate conditions by lowering the control level of automated driving when a boundary line of a recommended lane is not recognizable within a predetermined distance in the travel direction of the host vehicle M.

The above-mentioned embodiments can be expressed as follows:

a vehicle control device that controls automated driving of a vehicle, the vehicle control device including:

a storage device that stores a program; and

a hardware processor,

wherein the hardware processor is configured to execute the program stored in the storage device to perform:
acquiring map information in which a recommended lane on a route to a destination of the vehicle is identified;
controlling a control level of the automated driving on the basis of the acquired map information; and
lowering the control level of the automated driving when a boundary line of the recommended lane is not recognizable within a predetermined distance in a travel direction of the vehicle.

While an embodiment of the present invention has been described above, the present invention is not limited to the embodiment and can be embodied in various modifications and replacements without departing from the gist of the present invention.

What is claimed is:

1. A vehicle control device that controls automated driving of a vehicle, the vehicle control device comprising a processor configured to execute a program to perform:
acquiring map information in which a recommended lane on a route to a destination of the vehicle is identified; and
controlling a control level of the automated driving on the basis of the acquired map information,
wherein the processor is further configured to lower the control level of the automated driving when a boundary line of the recommended lane is not recognizable within a predetermined distance in a travel direction of the vehicle.

2. The vehicle control device according to claim 1, wherein the processor is further configured to lower the control level of the automated driving when a block obtained by dividing the route by every predetermined distance in the map information is not recognizable.

3. The vehicle control device according to claim 1, wherein the processor is further configured to lower the control level of the automated driving when a center line of the recommended lane in the map information is not recognizable.

4. The vehicle control device according to claim 1, wherein the processor is further configured to lower the control level of the automated driving when a branching lane is present in the map information and a main lane associated with the branching lane is not recognizable.

5. The vehicle control device according to claim 1, wherein the processor is further configured to lower the control level of the automated driving when information indicating presence of an exit lane as a connection destination of a certain lane is included in the map information and the exit lane is not recognizable.

6. The vehicle control device according to claim 1, wherein the processor is further configured to lower the control level of the automated driving when information of a median strip in the map information departs from a prescribed value.

7. The vehicle control device according to claim 1, wherein the processor is further configured to lower the control level of the automated driving when a merging lane is present in the map information and a neighboring lane associated with the merging lane is not recognizable.

8. The vehicle control device according to claim 1, wherein the processor is further configured to lower the control level of the automated driving when at least a part of the recommended lane in the map information is not recognizable.

9. The vehicle control device according to claim 1, wherein the processor is further configured to lower the control level of the automated driving when the map information is invalid.

10. The vehicle control device according to claim 1, wherein the processor is further configured to lower the control level of the automated driving when a lane in the map information is not recognizable.

11. A vehicle control method that is performed by a computer mounted in a vehicle, the control method comprising:
acquiring map information in which a recommended lane on a route to a destination of the vehicle is identified; and
controlling a control level of automated driving of the vehicle on the basis of the acquired map information,
wherein the controlling of the control level comprises lowering the control level of the automated driving when a boundary line of the recommended lane is not recognizable within a predetermined distance in a travel direction of the vehicle.

12. A non-transitory computer-readable storage medium storing a program, the program causing a computer mounted in a vehicle to perform:
acquiring map information in which a recommended lane on a route to a destination of the vehicle is identified; and
controlling a control level of automated driving of the vehicle on the basis of the acquired map information,
wherein the controlling of the control level comprises lowering the control level of the automated driving when a boundary line of the recommended lane is not recognizable within a predetermined distance in a travel direction of the vehicle.
